(19) United States
(12) Patent Application Publication
(10) Pub. No.: US 2024/0298154 A1
(43) Pub. Date: Sep. 5, 2024

(54) DRIVER-TO-DRIVER COMMUNICATION SYSTEM

(71) Applicant: Honda Motor Co., Ltd., Tokyo (JP)

(72) Inventor: Danyang TIAN, Ann Arbor, MI (US)

(21) Appl. No.: 18/177,384

(22) Filed: Mar. 2, 2023

(51) Int. Cl. H04W 4/46; G06V 20/58; H04N 7/18

(52) U.S. Cl. CPC H04W 4/46; G06V 20/58; H04N 7/183; G01S 13/42; G01S 13/91; G01S 17/42; G01S 17/88; G06V 20/625; G06V 2201/08; H04W 84/12

(57) ABSTRACT

A system and method for enabling driver-to-driver communication includes a host vehicle with one or more cameras, one or more sensors, a router broadcasting a wireless local area network, and an onboard unit. The onboard unit uses information from the cameras and sensors to identify and determine the relative positions of one or more remote vehicles in proximity to the host vehicle. The onboard unit also receives unique communication identifiers for some of the remote vehicles. A driver is prompted to select a vehicle to message and the onboard unit sends a message based on the selection and the unique communication identifier for the remote vehicle.

### BACKGROUND

The present disclosure generally relates to vehicles and in particular to systems for communication between drivers in vehicles.

Driving often requires explicit communication with nearby drivers. For example, a driver may wave another driver into a merging lane, or wave to indicate that another driver can proceed first through an intersection with four-way stop signs. Modern vehicles are equipped with many autonomous systems, including many systems that facilitate communication between vehicles, as well as between vehicles and other devices. For example, using so-called “Vehicle to Everything” (or “V2X”) systems, vehicles can send and receive information from other vehicles, infrastructure, and/or other devices and systems. However, a low commercial penetration rate of such systems in vehicles on the road means that V2X communication is not always possible, as one or both vehicles may not have the necessary V2X capabilities.

There is a need in the art for a system and method that addresses the shortcomings discussed above.

### SUMMARY

The disclosed embodiments provide methods and systems for driver-to-driver communication.

In one aspect, the techniques described herein relate to a motor vehicle that includes a camera, a router broadcasting a wireless local area network, and an onboard unit. The onboard unit includes a processor and a non-transitory computer readable medium storing instructions that are executable by the processor to: receive a request to join the wireless local area network from a mobile device; receive a communication identifier over the wireless local area network from the mobile device, the communication identifier being associated to a second motor vehicle; obtain visual identification information for the second motor vehicle associated with the communication identifier; receive image information from the camera, and detect one or more motor vehicles using the image information; identify the second motor vehicle among the one or more motor vehicles using the visual identification information; determine a relative location of each of the one or more motor vehicles, including the second motor vehicle; display information indicating the relative location of each of the one or more motor vehicles, including the second motor vehicle; receive user input corresponding to the relative location of the second motor vehicle; and send a message to the mobile device over the wireless local area network using the communication identifier for the second motor vehicle.

In some aspects, the techniques described herein relate to a system for enabling communication between a driver of a host vehicle and drivers of one or more remote vehicles. The system includes a camera mounted within the host vehicle; a router mounted within the host vehicle and broadcasting a wireless local area network, and an onboard unit mounted within the host vehicle. The onboard unit includes a processor and a non-transitory computer readable medium storing instructions that are executable by the processor to: receive a request to join the wireless local area network from a mobile device; receive a communication identifier over the wireless local area network from the mobile device, the communication identifier being associated to a second motor vehicle; obtain visual identification information for the second motor vehicle associated with the communication identifier; receive image information from the camera, and detect one or more motor vehicles using the image information; identify the second motor vehicle among the one or more motor vehicles using the visual identification information; determine a relative location of each of the one or more motor vehicles, including the second motor vehicle; display information indicating the relative location of each of the one or more motor vehicles, including the second motor vehicle; receive user input from a driver of the host vehicle corresponding to the relative location of the second motor vehicle; and send a message to the mobile device over the wireless local area network using the communication identifier for the second motor vehicle.

In some aspects, the techniques described herein relate to a method, including: receiving, at a system within a first motor vehicle, a request to join a wireless local area network from a mobile device; receiving a communication identifier over the wireless local area network from the mobile device, the communication identifier being associated to a second motor vehicle; obtaining visual identification information for the second motor vehicle associated with the communication identifier; receiving image information from a camera, and detecting one or more motor vehicles using the image information; identifying the second motor vehicle among the one or more motor vehicles using the visual identification information; determining a relative location of each of the one or more motor vehicles, including the second motor vehicle; displaying information indicating the relative location of each of the one or more motor vehicles, including the second motor vehicle; receiving user input corresponding to the relative location of the second motor vehicle; and sending a message to the mobile device over the wireless local area network using the communication identifier for the second motor vehicle.

Other systems, methods, features, and advantages of the disclosure will be, or will become, apparent to one of ordinary skill in the art upon examination of the following figures and detailed description. It is intended that all such additional systems, methods, features, and advantages be included within this description and this summary, be within the scope of the disclosure, and be protected by the following claims.

### BRIEF DESCRIPTION OF THE DRAWINGS

The embodiments can be better understood with reference to the following drawings and description. The components in the figures are not necessarily to scale, emphasis instead being placed upon illustrating the principles of the embodiments. Moreover, in the figures, like reference numerals designate corresponding parts throughout the different views.

FIGS. 1-3 present schematic views of a situation in which a first driver of a first vehicle communicates with a second driver of a second vehicle, where the second vehicle is in a blind spot of the first vehicle, according to an embodiment.

FIG. 4 is a schematic view of a system that can facilitate driver-to-driver communication, even when one vehicle lacks onboard communication infrastructure, according to an embodiment.

FIG. 5 is a schematic detailed view of an onboard unit and a mobile device, according to an embodiment.

FIG. 6 is a schematic view of a system where both host vehicle drivers and remote vehicle drivers may register with a common platform prior to communication using the exemplary architecture, according to an embodiment.

FIG. 7 is a schematic view of a process for sending messages to a driver in a remote vehicle, according to an embodiment.

FIG. 8 is a schematic view of a process for receiving messages for a driver in a remote vehicle, according to an embodiment.

FIG. 9 is a schematic view showing how the exemplary system could identify different remote vehicles based on images from vehicle cameras as well as using visual identification information.

FIG. 10 is a schematic view of a display showing vehicles for a driver to select.

### DETAILED DESCRIPTION

Some motor vehicles (or simply vehicles) may be equipped with systems that enable so-called “V2X” or “Vehicle to Everything” communication. V2X systems may include more specific vehicle communication systems, such as V2I (vehicle-to-infrastructure), V2N (vehicle-to-network), V2V (vehicle-to-vehicle), V2P (vehicle-to-pedestrian), and V2D (vehicle-to-device). In situations where two vehicles both have V2X capabilities, passing messages between drivers of the vehicles may be facilitated by the existing V2X infrastructure. In some cases, messages are passed and include GPS locations of the transmitting vehicles, which may be used along with V2X capabilities to automatically determine the locations of vehicles sending and receiving messages to one another.

However, if the commercial penetration of V2X systems is low in various categories of vehicles (such as cars, trucks, SUVs, vans, and other vehicles) and/or in particular geographic areas, not all vehicles encountering one another on the road may be equipped with V2X communications. In these situations, it may be more difficult to enable direct driver-to-driver (“D2D”) communication. In particular, when only one vehicle has V2X capabilities, it may be very difficult to determine precise locations for vehicles communicating over any wireless networks. The exemplary systems and methods provide a way for a driver of a V2X equipped vehicle to communicate with other vehicles that may not be V2X equipped. In particular, the exemplary systems and methods provide a way for a driver of a V2X equipped vehicle to identify a target vehicle, among multiple nearby vehicles, so that the driver can send messages to (and receive messages from) a driver in the target vehicle which may not be V2X equipped.

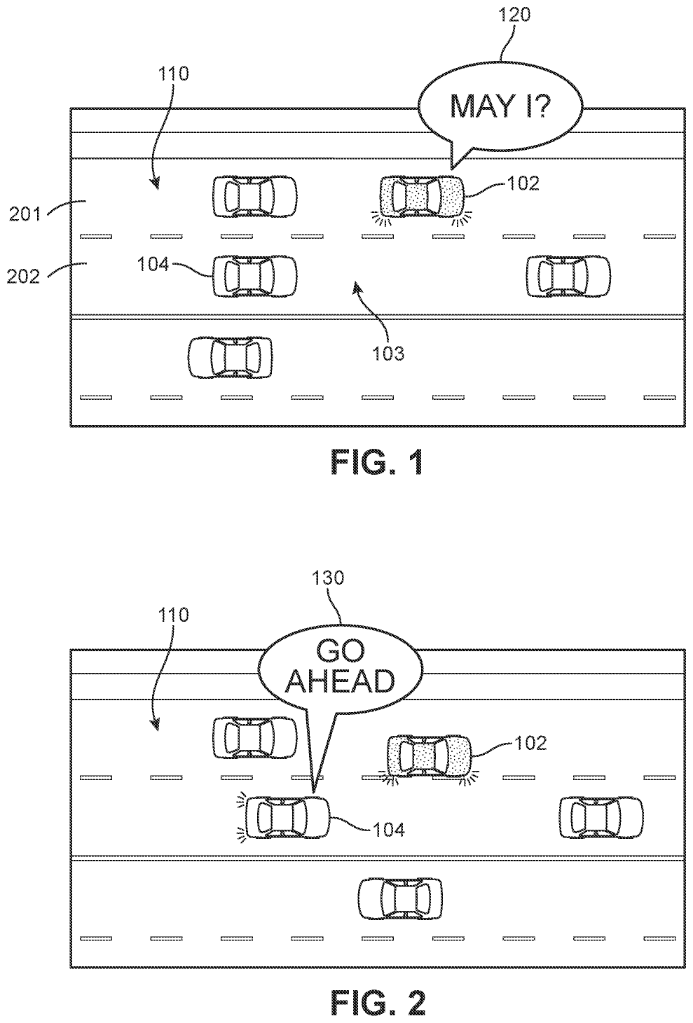

FIGS. 1-3 present schematic views of a situation in which a first driver of a first vehicle would like to communicate with a second driver of a second vehicle, where the second vehicle is in a blind spot of the first vehicle. Specifically, the first driver would like to ask permission to change lanes in front of the second vehicle. Referring to FIG. 1, a road (e.g., a highway 110) includes two lanes of vehicles traveling in the same direction, a first lane 201 and a second lane 202. A first vehicle 102 is positioned in the first lane 201 and a second vehicle 104 is positioned in the second lane 202. In the illustrated embodiment, the second vehicle 104 is situated approximately in a blind spot 103 of the first vehicle 102. Before attempting to change from first lane 201 to second lane 202 I front of second vehicle 104, the driver of first vehicle 102 makes a request 120 (“May I?”) indicating their desire to change lanes directly in front of second vehicle 104. In particular, this message is passed from first vehicle 102 to second vehicle 104 and displayed or otherwise presented to the driver of second vehicle 104.

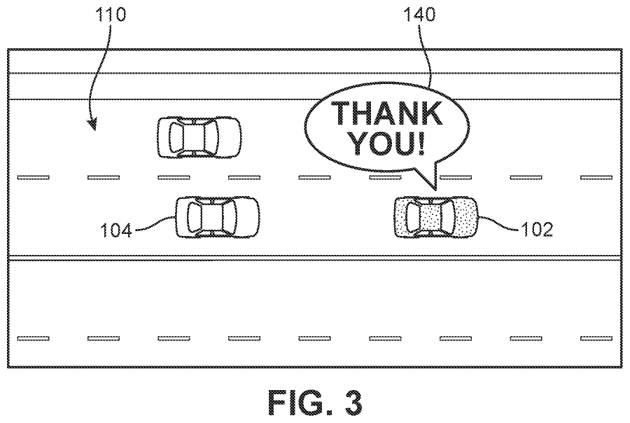

In FIG. 2, the driver of second vehicle 104 has received the request 120 and sent back a response 130 (“Go ahead”), and first vehicle 102 has started to change lanes in front of second vehicle 104. Finally, in FIG. 3, the driver of first vehicle 102 may send a message of appreciation 140 (“Thank you!”), after first vehicle 102 has finished changing lanes.

In the exemplary embodiments first vehicle 102 is configured with V2X, or similar vehicle-to-vehicle, capabilities, while second vehicle 104 does not have any V2X capabilities. Instead, driver-to-driver messages are passed between the two vehicles using a communication architecture 400 described herein. Communication architecture 400 allows messages to be passed from first vehicle 102 to a mobile device, such as a smartphone, associated with second vehicle 104, as described in further detail below. More specifically, the exemplary architecture allows a driver to select a particular vehicle (possibly among many) in proximity to their own vehicle so that messages can be passed to, and received from, the selected vehicle.

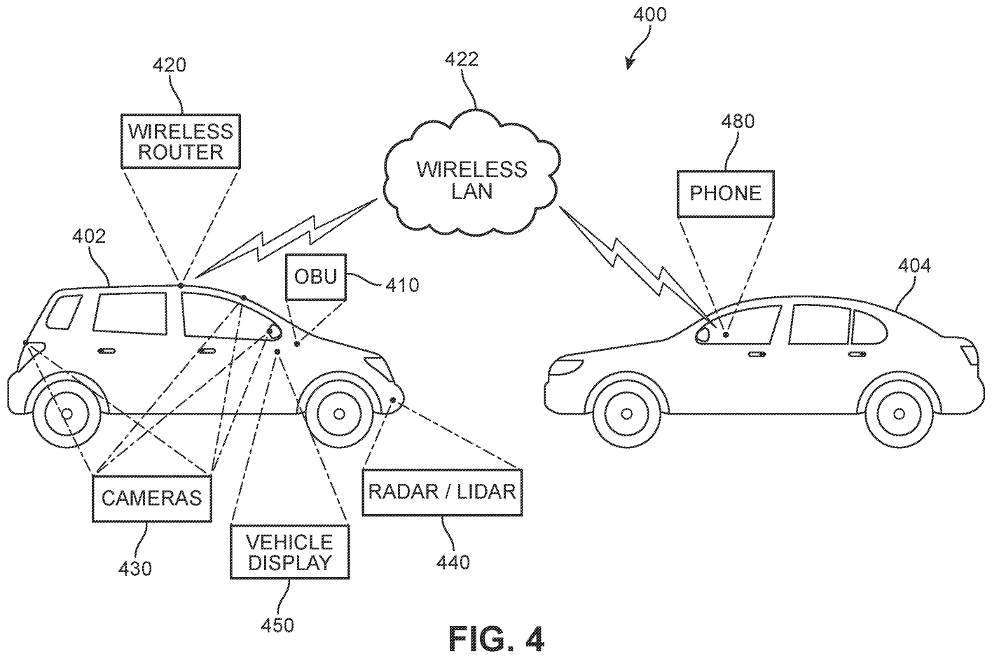

FIG. 4 is a schematic view of an exemplary embodiment of communication architecture 400 (or communication enabling system) that facilitates driver-to-driver communication, even when one vehicle lacks V2X capabilities or similar onboard communication infrastructure. Referring to FIG. 4, the architecture is configured as a host vehicle 402 and a remote vehicle 404. Host vehicle 402 is configured with various provisions that enable direct driver-to-driver communication even when remote vehicle 404 lacks V2X capabilities.

As used herein, the terms “host vehicle” and “remote vehicle” refer to relative vehicle configurations. A host vehicle may be any vehicle with components to enable the exemplary communication architecture, while a remote vehicle may be any vehicle proximate to a host vehicle, and which relies on a mobile phone or other mobile device for communication with the host vehicle. Moreover, it may be appreciated that a host vehicle may encounter, and communicate with, other host vehicles, either using the exemplary communication architecture, or by leveraging V2X capabilities of both vehicles. Likewise, a host vehicle could encounter any number of remote vehicles that are not equipped with similar provisions.

Host vehicle 402 may include an onboard unit 410 (or “OBU 410”). Host vehicle 402 may also include a wireless router 420 that is configured to broadcast a wireless local area network 422 (or “WLAN 422”). Using wireless router 420, OBU 410 can communicate with suitably equipped devices within remote vehicle 404, whenever remote vehicle 404 is within range of WLAN 422. In the exemplary configuration, OBU 410 can communicate with a mobile device 480, which is located within remote vehicle 404, over WLAN 422. In this example, mobile device 480 is a mobile phone.

Host vehicle 402 may also include provisions for sensing nearby vehicles, to identify and/or locate a given remote vehicle in the proximity of host vehicle 402. Host vehicle 402 may include one or more vehicle cameras 430. These can include, but are not limited to, forward facing cameras, rearward facing cameras and blind spot cameras (which may be located on a side-view mirror, for example). In some embodiments, host vehicle 402 could include any other number of cameras, including cameras that can be dynamically oriented in any desired direction and/or including a suite of cameras that collectively capture substantially a three hundred and sixty degree view around the host vehicle.

Host vehicle 402 can also include sensors 440. Sensors 440 can comprise RADAR and/or LIDAR devices, for example. In some cases, host vehicle 402 may include a blind spot monitoring sensor. Such a sensor could comprise a RADAR based device that is located and oriented to face towards a vehicle's blind spot. Data received from cameras 430 and sensors 440 may be combined by vehicle processors to provide a 360 degree surround view around host vehicle 402 and informing the driver of vehicles detected within that surround view.

Host vehicle 402 may also include a vehicle display 450. Vehicle display 450 may be used to display messages and/or provide an interface for drivers to create, select, and/or send messages. Vehicle display 450 could be an integrated display, such as a touchscreen integrated into a vehicle dashboard and/or center console. In some embodiments, vehicle display 450 could be part of a mobile device, such as a mobile phone disposed within host vehicle 402. In some cases, vehicle display 450 could comprise components for displaying visual elements onto a windshield of the host vehicle. For example, vehicle display 450 could include elements of an augmented reality system or heads up display.

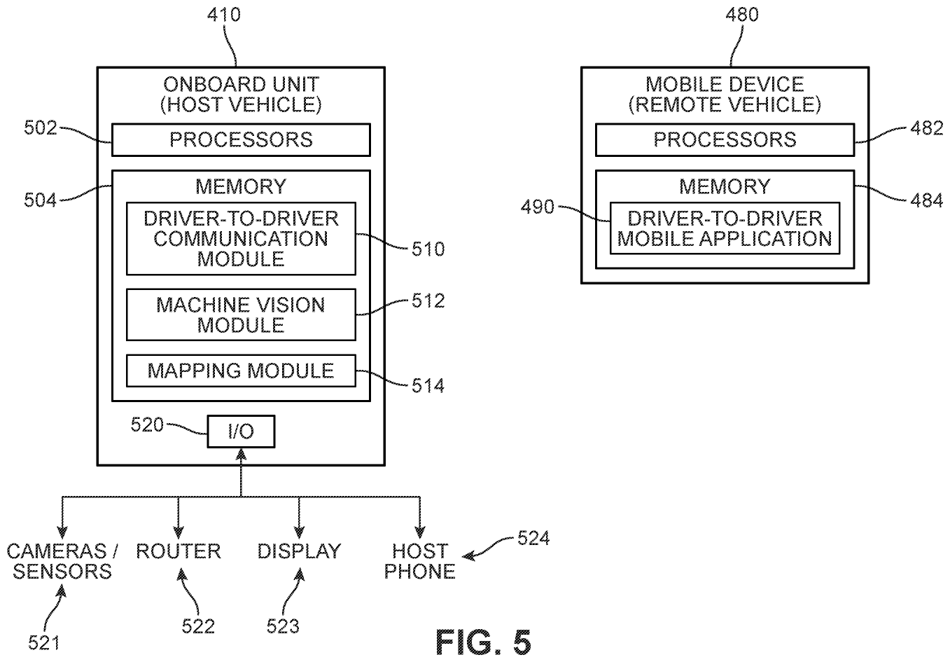

FIG. 5 is a schematic detailed view of OBU 410 and mobile device 480. Referring to FIG. 5, OBU 410 includes one or more processors 502 and memory 504. Memory 504 may comprise a non-transitory computer readable medium storing instructions that can be executed by the one or more processors 502. In the exemplary embodiment, OBU 410 may comprise one or more modules to facilitate driver-to-driver communication, including a driver-to-driver communication module 510, a machine vision module 512, and a mapping module 514.

Driver-to-driver communication module 510 may include algorithms that facilitate communication between OBU 410 and other devices, such as mobile device 480. In particular, this module may facilitate both the transfer of information over a wireless network, and also facilitate receiving inputs from, and displaying information for, the driver within the host vehicle.

Machine vision module 512 may comprise any suitable algorithms for object detection and/or object recognition, which may be useful in identifying remote vehicles as discussed in further detail below. Exemplary algorithms could comprise deep neural networks, including convolutional neural networks (CNNs), or any other suitable machine learning systems. As another example, any suitable algorithms for character recognition could be used to detect license plate numbers in an image. Machine vision module 512 may be used in analyzing images from one or more cameras of host vehicle 402.

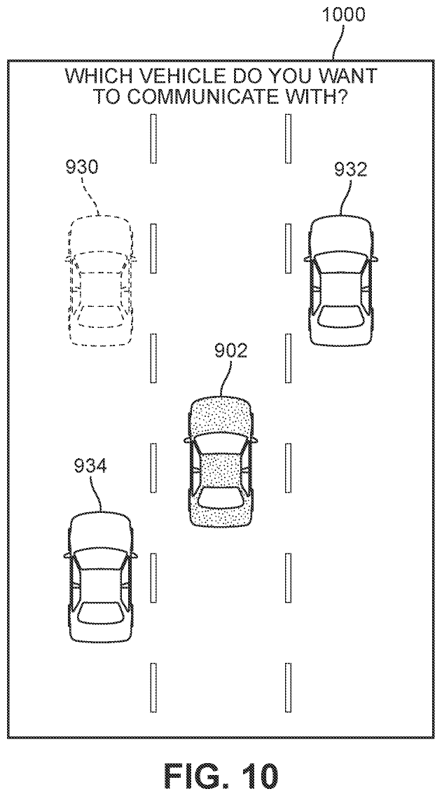

Mapping module 514 may comprise any suitable algorithms for determining the position(s) of one or more remote vehicles according to various kinds of input information. In particular, based on input information, mapping module 514 may determine the relative locations (locations relative to the host vehicle) of one or more remote vehicles. In some cases, the locations may be two-dimensional locations, indicating where a remote vehicle is relative to a host vehicle with respect to the front-back and left-right directions of the vehicle. In other cases, the locations could be three dimensional. Mapping module 514 may also comprise algorithms for building a visualization, or map, of the remote vehicles that are nearby the host vehicle. An exemplary map is shown in FIG. 10 and can be used by a driver to designate a particular remote vehicle for sending a message. Exemplary data that could be used by mapping module 514 include LIDAR data, RADAR data, as well as image data.

OBU 410 may also include various input-output (“I/O”) controllers 520 for interfacing with other components of a host vehicle and/or other systems. In this example, controllers 520 facilitate receiving information from cameras/sensors (components 521), from a router (component 522), from a display (component 523) and from a phone (or other mobile device) located within the host vehicle (component 524).

Mobile device 480 may also comprise one or more processors 482 and memory 484. Memory 484 may comprise a non-transitory computer readable medium storing instructions that can be executed by the one or more processors 482. As seen in FIG. 5, mobile device 480 may include a driver-to-driver mobile application 490, which is stored in memory 484.

Mobile application 490 may run on mobile device 480 and utilize hardware components of mobile device 480 to facilitate communication with OBU 410 over a wireless network. In some cases, mobile application 490 may be downloaded by a user and installed on mobile device 480. Mobile application 490 may comprise algorithms for receiving messages from, and sending messages to, OBU 410. In addition, mobile application 490 can include provisions for displaying messages to a driver within the corresponding remote vehicle.

In order to facilitate communication between an onboard unit and a mobile device, the exemplary embodiments utilize a registration system whereby all drivers intending to use the system (including as drivers of a host vehicle or of a remote vehicle) may register as users on a platform. Each user is assigned a unique communication identifier that allows host vehicles and remote vehicles to automatically connect via the host vehicle's wireless LAN when they are located sufficiently close to one another (that is, when they are separated by a distance less than the maximum range of the wireless LAN). In particular, an OBU of a host vehicle may permit a mobile device with a known unique communication identifier to join its own wireless network. Likewise, a mobile application running on a mobile device in a remote vehicle may automatically attempt to join any wireless networks associated with a known unique communication identifier. The use of unique communication identifiers allows the communication systems to be secured and also helps a host system in identifying those nearby vehicles and/or mobile devices that are open to, and/or capable of, sending and receiving messages with the host.

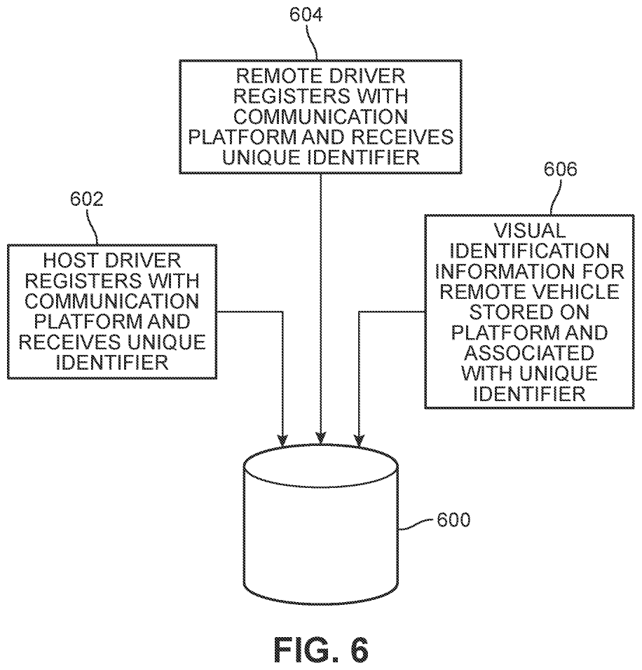

FIG. 6 is a schematic view of a system where both host vehicle drivers and remote vehicle drivers may register with a common platform prior to communication using the exemplary architecture. To register, a user may create or login to an existing account associated with a platform 600. The registration process could include providing personal information as well as information about the user's vehicle. As seen in FIG. 6, a host can register with platform 600 and receives, as part of the registration process, a unique communication identifier (registration step 602). When registering, the host can provide information indicating that they have a vehicle with the requisite capabilities to act as a host for facilitating driver-to-driver communication.

Additionally, a remote driver can register with platform 600 and also receives a corresponding unique communication identifier (registration step 604). In addition to providing personal information, a remote driver also provides information about the remote vehicle in which the remote driver and the remote driver's mobile device will be in while using platform 600. Specifically, the remote driver can provide visual identification information that can be used by a host vehicle to identify the remote vehicle (registration step 606). The visual identification information can be associated with the remote driver's unique communication identifier so that the visual identification information can be retrieved for use by a host vehicle at a later time.

Different embodiments may utilize different kinds of vehicle identification information. In some embodiments, the vehicle identification information can comprise a license plate number which could be captured by the host vehicle with a camera and analyzed using suitable machine vision software. In other embodiments, the vehicle identification information could include the make, model, and color of the remote vehicle, which may also be detected using suitable machine vision software at the host vehicle. Furthermore, the vehicle identification information may include information associated with a bar code, a quick response (QR) code, and/or other visual identifiers physically displayed on the exterior of a remote vehicle.

The registration information can be maintained in storage (for example, in a database) managed by the platform. The host vehicle can either retrieve the necessary information about the remote vehicle (including the visual identification information) directly from the platform or from the remote vehicle itself which may store a local copy of this information and transmit it to the host vehicle.

The information gathered during the registration process, including the unique communication identifiers, could be accessed through a mobile application. For example, a mobile application running on a mobile device could have access to information stored on the platform. In some cases, the onboard unit of a host vehicle could have access to information stored on the platform. The access could be obtained directly by the onboard unit over a network, or via a mobile application running on a mobile device within the host vehicle.

In one embodiment, remote drivers could, prior to driving, open and log into a mobile application that may continue to search for any wireless LANs associated with host vehicles (determined by a unique communication identifier broadcasted by the host).

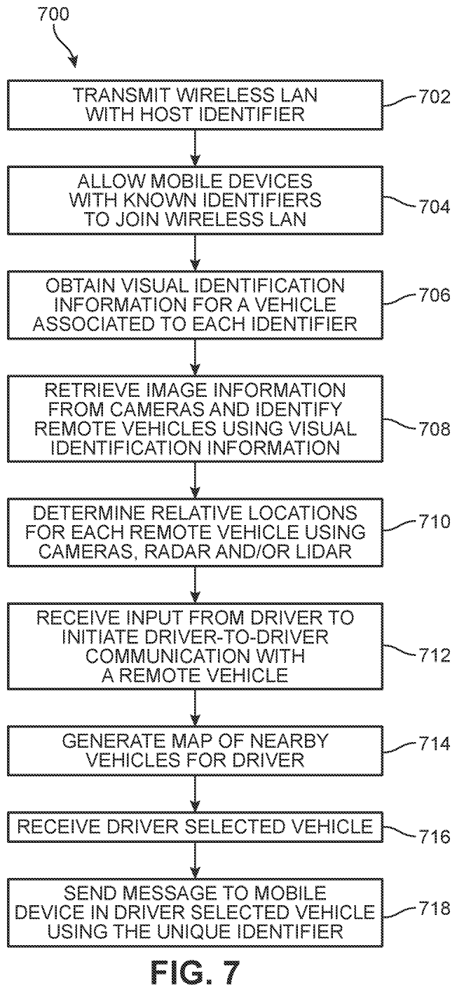

FIG. 7 is a schematic view of a process for sending messages to a driver in a remote vehicle, according to an embodiment. The exemplary process may be performed by one or more systems, devices, or components of a host vehicle. In an exemplary embodiment, one or more steps may be performed by OBU 410 (see FIG. 4).

In a first step 702 of a process 700, OBU 410 may transmit a wireless LAN along with a unique communication identifier for the host vehicle/host driver. This “host identifier” may be used by remote vehicles to determine that the wireless LAN is safe to connect with. In a second step 704, OBU 410 receives requests from one or more mobile devices with known unique communication identifiers (“remote identifiers”) and allows the mobile devices to join the wireless LAN.

Next, in step 706, OBU 410 may obtain visual identification information for each mobile device in a remote vehicle that has (or is currently) connected to the wireless LAN using a unique communication identifier. In particular, for each different communication identifier accessing the wireless LAN, OBU 410 obtains visual identification information for the remote vehicle corresponding to that communication identifier. In some embodiments, the visual identification information may be sent by the corresponding mobile device to the host vehicle when the mobile device joins the wireless LAN. In other embodiments, OBU 410 retrieves the visual identification information from storage by using the unique communication identifier of the remote vehicle as a key. This information could be stored locally or could be retrieved from a platform (such as platform 600 of FIG. 6) that may be accessible remotely (for example, through the cloud).

In step 708, OBU 410 may retrieve information from one or more cameras on the host vehicle. These could include, for example, images from cameras 430 of host vehicle 402 (see FIG. 4). OBU 410 may use machine vision to process the images to identify any remote vehicles. This may include comparing features of vehicles in the images with known visual identification information for one or more remote vehicles. As an example, OBU 410 could detect a vehicle license plate in an image from a forward facing camera and extract the license plate number. OBU 410 could then check if the extracted license plate number matches the license plate number associated with any known communication identifiers. If a match is found, OBU 410 infers that the remote vehicle associated with the unique communication identifier is located ahead of the host vehicle, as it was detected with a forward facing camera.

When processing images, OBU 410 may detect the presence any number of vehicles in proximity to the host vehicle. Some of the detected vehicles may be further identified as corresponding to known remote vehicles based on the provided visual identification information. However, other vehicles may not be identifiable, since not all vehicles will be registered with the platform. In such cases, OBU 410 could still determine a vehicle is present, using object recognition for example, and note it is unidentified.

In step 710, OBU 410 may determine the locations, relative to the host vehicle, of any detected vehicles using images from one or more cameras, as well as using any received RADAR and/or LIDAR data. In some cases, the approximate relative locations of other vehicles around a host vehicle could be inferred from images, based on a combination of knowing the source camera (for example, if it is a forward or rearward facing camera) and based on analysis of the images which may be used to reconstruct approximate relative positions and orientations of the remote vehicles. In some cases where RADAR and/or LIDAR data are available, the data may be used to measure relative distances to vehicles, thereby providing additional information for reconstructing the relative locations of the remote vehicles. In some cases, this data could be combined with GPS information received from the mobile device in the remote vehicle, to further determine the relative locations of each vehicle.

In step 712, OBU 410 may receive input indicating that a driver would like to initiate driver-to-driver communication with a remote vehicle. For example, a driver could indicate their intention to ask a particular vehicle if they can change lanes ahead of that vehicle, as in the example of FIGS. 1-3. The input could be received via voice commands and/or touch-based commands. In some embodiments, a driver could touch an input button on a display screen within the vehicle. The display screen could be an onboard vehicle display or the display of a mobile phone, for example.

Upon receiving input indicating that the driver would like to contact a vehicle, OBU 410 may take steps to determine which vehicle (possibly of many in proximity to the host vehicle) the driver would like to contact. In step 714, OBU 410 builds a real-time object map of the vehicles around the host vehicle, which can then be displayed for a user, for example, on a vehicle display or on a mobile phone display. The driver can view the display and select a particular remote vehicle for messaging. As an example, with respect to the configuration of FIG. 1, the driver could select remote vehicle 104 from among multiple vehicles on a display, as this is the vehicle that the driver intends to pass (and therefore wishes to communicate with). In step 716, OBU 410 receives a driver selected vehicle. This may be determined when the driver touches a particular vehicle on the display screen.

In step 718, OBU 410 may send a message to the mobile device in the driver selected vehicle. Specifically, OBU 410 sends a message to the mobile device associated with the known unique communication identifier that has already been matched to the driver selected vehicle.

Once communication has been initiated with a remote vehicle, OBU 410 can continue sending new messages as in step 718. For example, in response to receiving the message “Go ahead” in the scenario of FIG. 2, OBU 410 could respond with a “Thank you!”, as in FIG. 3. This could be automatically generated by OBU 410 upon determining that the task has been completed, or could be specifically selected by the driver to be sent after successfully passing the remote vehicle.

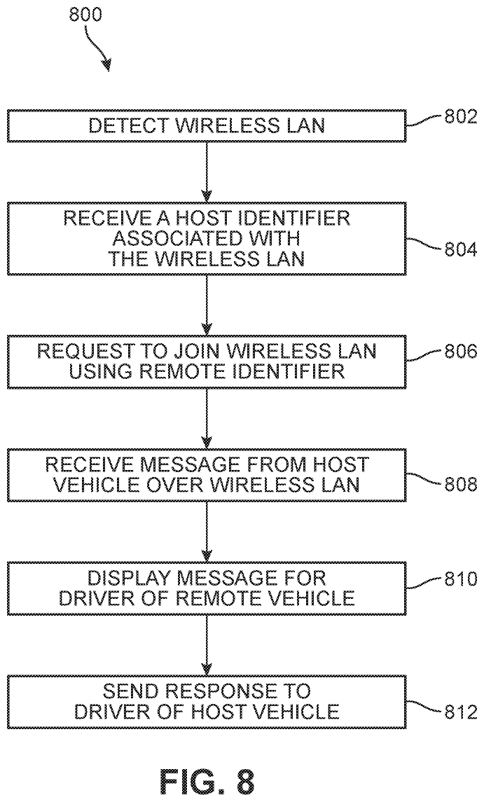

FIG. 8 is a schematic view of a process for receiving messages for a driver in a remote vehicle, according to an embodiment. In an exemplary embodiment, one or more steps may be stored as instructions in a mobile application that can run on a mobile device (such as mobile application 490 of FIG. 5).

In step 802 of a process 800, a mobile application may detect a wireless LAN. In step 804, the mobile application can receive a host identifier associated with the wireless LAN. Next, the mobile application can request to join the wireless LAN based on the host identifier in step 806. In some cases, before joining the wireless LAN, the mobile application checks the host identifier against known identifiers (stored in memory or stored remotely), to confirm that the wireless LAN can be joined. In order to be permitted to join, the mobile application may provide the remote identifier to the host system. In step 808, the mobile application may receive a message from the host vehicle over the wireless LAN. In step 810, the mobile application may display the message for the driver of the remote vehicle. In step 812, the mobile application could send a response to the driver of the host vehicle. The response could be automatically selected by the system, or may be selected by the driver of the remote vehicle.

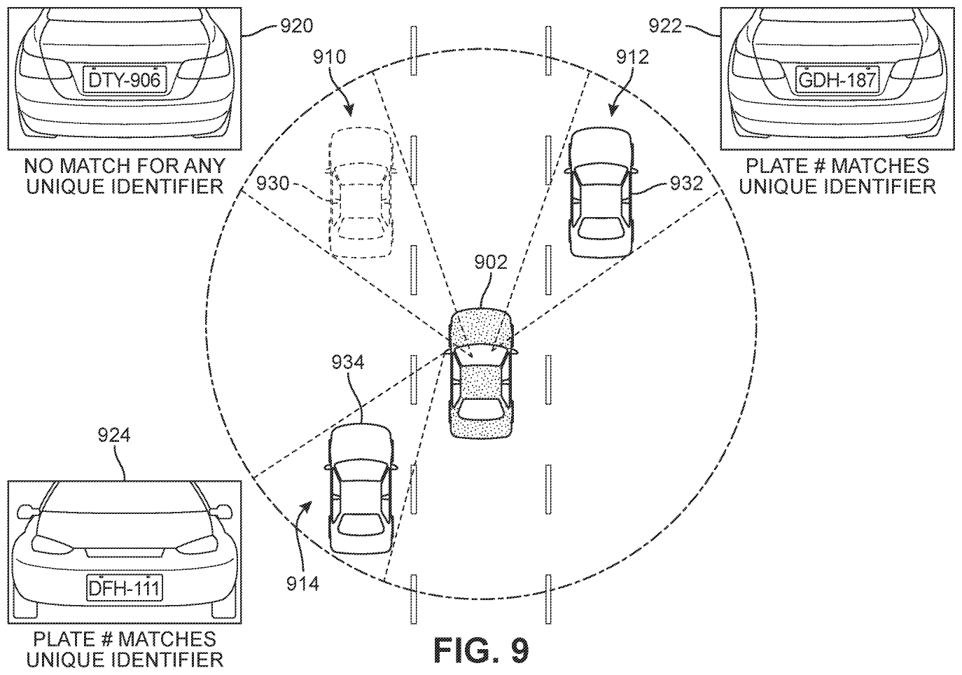

FIG. 9 is a schematic view showing how the exemplary system could identify different remote vehicles based on images from vehicle cameras as well as using visual identification information. Referring to FIG. 9, images of vehicles in the proximity of a host vehicle 902 could be captured using various cameras. For example, a first forward facing camera (not shown) with a viewing range 910 captures a first image 920 of a first remote vehicle 930 and a second forward facing camera (not shown) with a viewing range 912 captures a second image 922 of a second remote vehicle 932. A blind spot camera (not shown) with a viewing area 914 captures a third image 924 of a third remote vehicle 934.

The captured images can be analyzed using machine vision to determine if any of the vehicles match known visual identification information for vehicles currently connected to the host's wireless LAN. If so, the corresponding vehicle can be matched to a known unique communication identifier. For example, second image 922 is analyzed to extract a license plate number for second remote vehicle 932, which is found to match the license plate number for a known unique communication identifier (and associated remote vehicle). Likewise, third image 924 is analyzed to extract a license plate number for third remote vehicle 934, which is found to match the license plate number for another known unique communication identifier (and associated remote vehicle). By contrast, the license plate number extracted for first remote vehicle 930 does not match any known unique communication identifier, indicating that host vehicle 902 cannot communicate with first remote vehicle 930.

As already discussed, once remote vehicles have been matched to any known unique communication identifiers, the relative locations of the remote vehicles around the host vehicle can be inferred using image information, RADAR data, LIDAR data, and or a combination of different types of data. These relative locations can then be displayed, for a user, on a display screen 1000, as in FIG. 10. A driver can then be promoted to select which vehicle the driver would like to communicate with. For example, if the driver intends to pass second remote vehicle 932, the driver could select the associated icon for second remote vehicle 932 on a touch-based display. Because the system has already matched second remote vehicle 932 to a known unique communication identifier, this allows the system to send and receive messages over the wireless LAN, directly to (and only to) the designated vehicle.

It may be appreciated that the embodiments are not limited to use in particular driving scenarios, and that the exemplary systems and methods can be used for any situations where driver-to-driver communication is useful and/or necessary. Moreover, while the embodiments describe scenarios where a driver makes a request and receives a response from another driver, in other embodiments, messages of appreciation (such as “Thank you!”) can be sent after a particular event, even if no request is ever made.

In some embodiments, messages could be predetermined for various kinds of scenarios, so that drivers can simply select one message from of a list of preset messages to send to other vehicles. In other embodiments, drivers could generate custom messages, for example, using voice recognition.

The foregoing disclosure of the embodiments has been presented for purposes of illustration and description. It is not intended to be exhaustive or to limit the embodiments to the precise forms disclosed. Many variations and modifications of the embodiments described herein will be apparent to one of ordinary skill in the art in light of the above disclosure.

While various embodiments have been described, the description is intended to be exemplary, rather than limiting, and it will be apparent to those of ordinary skill in the art that many more embodiments and implementations are possible that are within the scope of the embodiments. Any feature of any embodiment may be used in combination with or substituted for any other feature or element in any other embodiment unless specifically restricted. Accordingly, the embodiments are not to be restricted except in light of the attached claims and their equivalents. Also, various modifications and changes may be made within the scope of the attached claims.

Further, in describing representative embodiments, the specification may have presented a method and/or process as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process should not be limited to the performance of their steps in the order written, and one skilled in the art can readily appreciate that the sequences may be varied and still remain within the spirit and scope of the present embodiments.

1. A motor vehicle, comprising:
a camera;
a router broadcasting a wireless local area network; and
an onboard unit, the onboard unit comprising a processor and a non-transitory computer readable medium storing instructions that are executable by the processor to:
receive a request to join the wireless local area network from a mobile device;
receive a communication identifier over the wireless local area network from the mobile device, the communication identifier being associated with a second motor vehicle;
obtain visual identification information for the second motor vehicle associated with the communication identifier;
receive image information from the camera, and detect one or more motor vehicles using the image information;
identify the second motor vehicle among the one or more motor vehicles using the visual identification information;
determine a location, relative to the host vehicle, of each of the one or more motor vehicles, including the second motor vehicle;
display information indicating the relative location of each of the one or more motor vehicles, including the second motor vehicle;
receive user input corresponding to the second motor vehicle; and
send a message to the mobile device over the wireless local area network using the communication identifier for the second motor vehicle.

2. The motor vehicle according to claim 1, wherein the instructions are further executable by the processor to receive a response to the message over the wireless local area network.

3. The motor vehicle according to claim 2, wherein the message is a request for the motor vehicle to pass the second motor vehicle on a roadway.

4. The motor vehicle according to claim 1, wherein the visual identification information includes a license plate number.

5. The motor vehicle according to claim 1, wherein the visual identification information comprises at least one physical attribute of the second motor vehicle.

6. The motor vehicle according to claim 5, wherein the at least one physical attribute is one of a make, model, or color of the second motor vehicle.

7. The motor vehicle according to claim 1, wherein the instructions are further executable by the processor to obtain visual identification information by looking up the visual identification information in storage using the communication identifier.

8. The motor vehicle according to claim 1, wherein the instructions are further executable by the processor to obtain visual identification information by receiving the visual identification information from the mobile device over the wireless local area network.

9. The motor vehicle according to claim 1, wherein the motor vehicle further includes a LIDAR sensor; and wherein the instructions are further executable by the processor to determine the relative location of each of the one or more motor vehicles using information from the LIDAR sensor.

10. The motor vehicle according to claim 1, wherein the motor vehicle further includes a RADAR sensor; and wherein the instructions are further executable by the processor to determine the relative location of each of the one or more motor vehicles using information from the RADAR sensor.

11. A system for enabling communication between a driver of a host vehicle and drivers of one or more remote vehicles, the system further comprising:
a camera mounted within the host vehicle;
a router mounted within the host vehicle and broadcasting a wireless local area network; and
an onboard unit mounted within the host vehicle, the onboard unit comprising a processor and a non-transitory computer readable medium storing instructions that are executable by the processor to:
receive a request to join the wireless local area network from a mobile device;
receive a communication identifier over the wireless local area network from the mobile device, the communication identifier being associated to a second motor vehicle;
obtain visual identification information for the second motor vehicle associated with the communication identifier;
receive image information from the camera, and detect one or more motor vehicles using the image information;
identify the second motor vehicle among the one or more motor vehicles using the visual identification information;
determine a location, relative to the host vehicle, of each of the one or more motor vehicles, including the second motor vehicle;
display information indicating the relative location of each of the one or more motor vehicles, including the second motor vehicle;
receive user input from a driver of the host vehicle corresponding to the second motor vehicle; and
send a message to the mobile device over the wireless local area network using the communication identifier for the second motor vehicle.

12. The system according to claim 11, further comprising a non-transitory computer-readable medium storing software comprising instructions executable by one or more computers which, upon such execution, cause the one or more computers to:
receive a second communication identifier associated with the host vehicle;
join the wireless local area network based on the second communication identifier;
receive the message from the onboard unit over the wireless local area network; and
display, for a driver of the second motor vehicle, information about the message.

13. The system according to claim 12, wherein the instructions are further executable to:
receive second user input from the driver of the second motor vehicle; and
send a response to the onboard unit, via the wireless local area network, based on the second user input.

14. The system according to claim 12, wherein the non-transitory computer readable medium storing software is associated with the mobile device.

15. The system according to claim 14, wherein the software is a mobile application that runs on the mobile device.

16. A method, comprising:
receiving, at a system of a first motor vehicle, a request to join a wireless local area network from a mobile device;
receiving a communication identifier over the wireless local area network from the mobile device, the communication identifier being associated to a second motor vehicle;
obtaining visual identification information for the second motor vehicle associated with the communication identifier;
receiving image information from a camera, and detecting one or more motor vehicles using the image information;
identifying the second motor vehicle among the one or more motor vehicles using the visual identification information;
determine a location, relative to the first motor vehicle, of each of the one or more motor vehicles, including the second motor vehicle;
displaying information indicating the relative location of each of the one or more motor vehicles, including the second motor vehicle;
receiving user input corresponding to the relative location of the second motor vehicle; and
sending a message to the mobile device over the wireless local area network using the communication identifier for the second motor vehicle.

17. The method according to claim 16, wherein the method further includes receiving a response to the message over the wireless local area network.

18. The method according to claim 16, wherein the message is a request for the first motor vehicle to pass the second motor vehicle on a roadway.

19. The method according to claim 16, wherein the visual identification information includes a license plate number.

20. The method according to claim 16, wherein the visual identification information comprises at least one physical attribute of the second motor vehicle.
